(19) United States
(12) Patent Application Publication
(10) Pub. No.: US 2025/0279090 A1
(43) Pub. Date: Sep. 4, 2025

(54) Context-Aware Speech Recognition Using Prompts for Language Learners

(71) Applicant: Google LLC, Mountain View, CA (US)

(72) Inventor: Jian Cheng, Mountain View, CA (US)

(73) Assignee: Google LLC, Mountain View, CA (US)

(21) Appl. No.: 19/054,518

(22) Filed: Feb. 14, 2025

Related U.S. Application Data
(60) Provisional application No. 63/559,832, filed on Feb. 29, 2024.

(51) Int. Cl. G10L 15/06; G09B 19/06

(52) U.S. Cl. CPC G10L 15/063; G09B 19/06

(57) ABSTRACT

A method includes generating an initial prompt including a requested response and an ideal answer. The requested response is configured to elicit a user to speak a respective utterance in a first language. The ideal answer represents how to correctly respond to the requested response. The method includes transmitting the requested response to a user device associated with the user. The user includes a native speaker of a second language different than the first language. After transmitting the initial prompt to the user device, the method includes receiving the audio data associated with the respective utterance in the first language spoken by the user. The method includes conditioning a speech model on the initial prompt. The method includes generating, using the conditioned speech model, a speech recognition result based on the audio data.

### CROSS REFERENCE TO RELATED APPLICATIONS

This U.S. patent application claims priority under 35 U.S.C. § 119(e) to U.S. Provisional Application 63/559,832, filed on Feb. 29, 2024. The disclosure of this prior application is considered part of the disclosure of this application and is hereby incorporated by reference in its entirety.

### TECHNICAL FIELD

This disclosure relates to context-aware speech recognition using prompts for language learners.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Despite advancements, ASR systems still face challenges, particularly in accurately recognizing non-native accented speech. These challenges are especially pronounced in language learning applications, where precise recognition of grammar, usage, and pronunciation is critical for providing effective feedback. Traditional ASR systems often struggle with the variability and unpredictability of non-native speech, leading to errors that may hinder the learning process.

### SUMMARY

One aspect of the disclosure provides a computer-implemented method executed on data processing hardware that causes the data processing hardware to perform operations for context-aware speech recognition. The operations include generating an initial prompt that includes a requested response and an ideal answer. The requested response is configured to elicit a user to speak a respective utterance in a first language. The ideal answer represents how to correctly respond to the requested response. The operations include transmitting the requested response to a user device associated with the user. The user includes a native speaker of a second language different than the first language. After transmitting the initial prompt to the user device, the operations include receiving audio data associated with the respective utterance in the first language spoken by the user. The operations include conditioning a speech model on the initial prompt. The operations include generating, using the conditioned speech model, a speech recognition result based on the audio data.

Implementations of the disclosure may include one or more of the following optional features. In some implementations, the speech model includes an automatic speech recognition (ASR) model and generating the speech recognition result includes generating a higher order feature representation based on the audio data using an audio encoder of the ASR model, generating a dense representation using a prediction network of the ASR model based on a sequence of non-blank output symbols output by a final Softmax layer and the initial prompt, and generating the speech recognition result using a joint network of the ASR model based on the higher order feature representation and the dense representation. The speech model may be trained to recognize speech in the first language. In some examples, the speech model includes a multimodal large language model (LLM). The user may be learning to speak the first language.

In some implementations, the utterance in the first language spoken by the user includes an accent associated with speakers of the second language. The requested response may include a yes or no response based on a phrase presented to the user and the ideal answer includes yes or no. In some examples, the requested response includes at least one of the user repeating a phrase presented to the user, the user reading the phrase presented to the user, or the user retelling the phrase in their own words and the ideal answer includes the phrase. The requested response may include the user retelling a phrase associated with an image presented to the user in their own words and the ideal answer includes the phrase and the image. In some implementations, the requested response includes the user describing a silent video and the ideal answer includes the silent video. The initial prompt may further include a speaker turn boundary between the requested response and the ideal answer.

Another aspect of the disclosure provides a system that includes data processing hardware and memory hardware storing instructions that when executed on the data processing hardware causes the data processing hardware to perform operations. The operations include generating an initial prompt that includes a requested response and an ideal answer. The requested response is configured to elicit a user to speak a respective utterance in a first language. The ideal answer represents how to correctly respond to the requested response. The operations include transmitting the requested response to a user device associated with the user. The user includes a native speaker of a second language different than the first language. After transmitting the initial prompt to the user device, the operations include receiving audio data associated with the respective utterance in the first language spoken by the user. The operations include conditioning a speech model on the initial prompt. The operations include generating, using the conditioned speech model, a speech recognition result based on the audio data.

Implementations of the disclosure may include one or more of the following optional features. In some implementations, the speech model includes an automatic speech recognition (ASR) model and generating the speech recognition result includes generating a higher order feature representation based on the audio data using an audio encoder of the ASR model, generating a dense representation using a prediction network of the ASR model based on a sequence of non-blank output symbols output by a final Softmax layer and the initial prompt, and generating the speech recognition result using a joint network of the ASR model based on the higher order feature representation and the dense representation. The speech model may be trained to recognize speech in the first language. In some examples, the speech model includes a multimodal large language model (LLM). The user may be learning to speak the first language.

In some implementations, the utterance in the first language spoken by the user includes an accent associated with speakers of the second language. The requested response may include a yes or no response based on a phrase presented to the user and the ideal answer includes yes or no. In some examples, the requested response includes at least one of the user repeating a phrase presented to the user, the user reading the phrase presented to the user, or the user retelling the phrase in their own words and the ideal answer includes the phrase. The requested response may include the user retelling a phrase associated with an image presented to the user in their own words and the ideal answer includes the phrase and the image. In some implementations, the requested response includes the user describing a silent video and the ideal answer includes the silent video. The initial prompt may further include a speaker turn boundary between the requested response and the ideal answer.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing a conversational assistant.

FIG. 2 is a schematic view of an example automatic speech recognition model.

FIG. 3 is a flowchart of an example arrangement of operations for a computer-implemented method of context-aware speech recognition.

FIG. 4 is a schematic view of an example computing device that may be used to implement the systems and methods described herein.

Like reference symbols in the various drawings indicate like elements.

### DETAILED DESCRIPTION

Automatic speech recognition (ASR) systems are becoming increasingly popular as ASR systems enable users to interact with various applications and devices using natural speech. Recently, end-to-end (E2E) ASR models have gained popularity in achieving state-of-the-art performance in accuracy and latency. In contrast to conventional ASR systems that include separate acoustic, pronunciation, and language models, E2E ASR models apply a sequence-to-sequence approach to jointly learn acoustic and language modeling in a single neural network that is trained end to end from training data, e.g., utterance-transcription pairs. However, despite the advances, E2E ASR models still face challenges in recognizing speech from atypical users, such as non-native speakers, children, or speakers with accents or dialects. In some instances, ASR models generate inaccurate transcriptions that misrecognize what the user actually spoke, leading to user dissatisfaction.

ASR is a powerful tool for assessing and improving the speaking skills of language learners. However, ASR errors can lead to inaccurate feedback in grammar, usage, and pronunciation, which may hinder the learning process and outcomes. For instance, if an ASR system incorrectly transcribes a spoken sentence, the feedback provided may be misleading. As a result, the learner may practice incorrect pronunciations or grammar, which can be counterproductive to the learning process. For example, if a learner says “I am going to the store,” but the ASR system transcribes it as “I am going to the star,” the feedback might incorrectly focus on the word “star,” leading the learner to believe they mispronounced “store.” Moreover, language learners may have diverse backgrounds, proficiency levels, and learning goals, which require ASR systems to be adaptable and robust to different speech patterns and contexts. While E2E models have demonstrated improvements in decoding long-form utterances by integrating contextual information from previous utterances, which help resolve ambiguities and improve overall coherence, these models still struggle with the inherent variability of speech, especially from language learners. These improvements are particularly valuable for spoken language learning, where instructional applications often present short-spoken prompts (e.g., textual prompts and/or audio prompts) to elicit spoken responses.

Accordingly, implementations herein are directed towards a conversational assistant that generates an initial prompt including a requested response and an ideal answer. The requested response is configured to elicit a user to speak a respective utterance in a first language. The ideal answer represents how to correctly respond to the requested response. The conversational assistant transmits the requested response to a user device associated with the user. The user is a native speaker of a second language different than the first language. After transmitting the initial prompt to the user device, the conversational assistant receives audio data associated with the respective utterance in the first language spoken by the user. The conversational assistant conditions a speech model on the initial prompt. That is, the conversational assistant may condition the speech model on the requested response and/or the ideal answer. The conditioned speech model generates a speech recognition result based on the audio data.

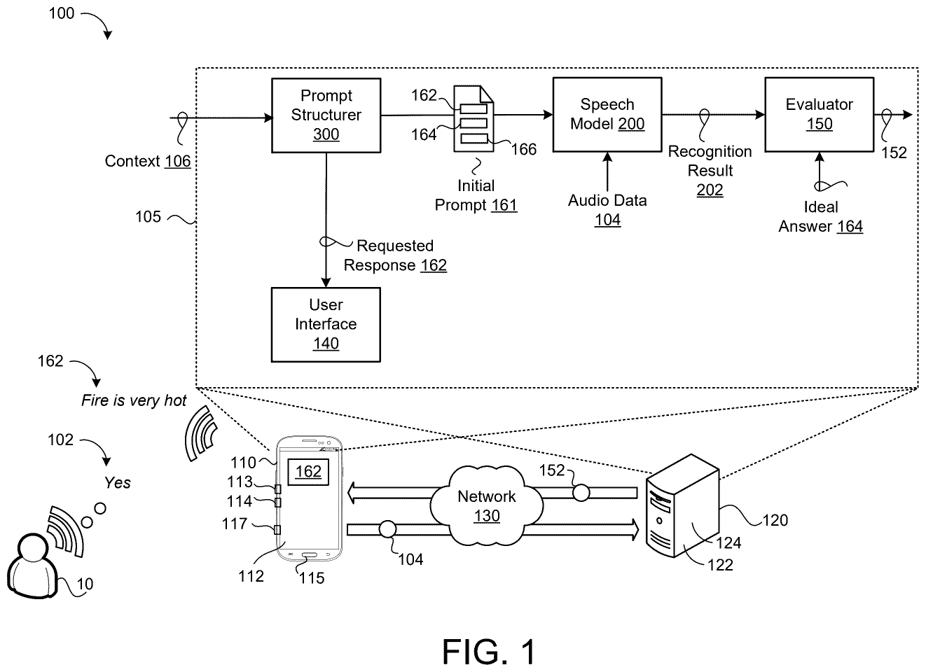

Referring to FIG. 1, in some implementations, a system 100 includes a remote computing system 120 in communication with one or more user device 110 each associated with a respective user (e.g., speaker) 10 via a network 130, such as the Internet, a local area network (LAN), a wide area network (WAN), a cellular network, or a wireless network. The remote computing system 120 may be a single computer, multiple computers, or a distributed system (e.g., a cloud environment) having scalable/elastic resources including computing resources 122 (e.g., data processing hardware) and/or storage resources 124 (e.g., memory hardware). The remote computing system 120 is configured to communicate with the user device 110 via the network 130. The user device may correspond to any computing device, such as a desktop workstation, a laptop workstation, or a mobile device (i.e., a smart phone). Each user device 110 includes computing resources 113 (e.g., data processing hardware) and/or storage resources 114 (e.g., memory hardware). The user device 110 may also include an audio input device (e.g., a microphone) 115 and an audio output device (e.g., a speaker) 117 for capturing and playing audio data, respectively. The user device 110 may further include a display device (e.g., a screen) 112 for presenting visual information to the user 10.

The remote computing system 120 and/or the user device 110 may execute a conversational assistant 105. In some examples, the remote computing system 120 executes the conversational assistant 105. In other examples, the user device 110 executes the conversational assistant 105. In yet other examples, some components of the conversational assistant 105 execute on the remote computing system 120 while other components of the conversational assistant 105 execute on the user device 110. The conversational assistant 105 may include a user interface 140, a prompt structurer 160, a speech model 200, and/or an evaluator 150.

The conversational assistant 105 enables the user 10 to interact with the conversational assistant 105 through spoken conversation. The user 10 may engage with the conversational assistant 105 in a first language to learn how to speak the first language despite the user 10 being a native speaker of a second language different than the first language. For example, the user 10 may be a native speaker of Spanish and interact with the conversational assistant 105 in English to practice and improve their English-speaking skills. The conversational assistant 105 may provide various spoken language learning activities to the user 10, such as reading, repeating, retelling, evaluating, or conversing in the first language. For instance, the user 10 may be asked to read a passage aloud, repeat a phrase, retell a story in their own words, evaluate a sentence, or engage in a conversation. These activities may be designed to enhance the user's 10 pronunciation, vocabulary, grammar, fluency, or comprehension of the first language. The conversational assistant 105 may also adapt the difficulty level, the feedback, and the guidance of the activities based on the proficiency level, learning goals, and performance of the user 10. For example, if the user 10 is a beginner, the conversational assistant 105 may start with simple phrases and gradually increase the complexity as the proficiency of the user 10 improves.

The prompt structurer 160 may generate initial prompts 161 configured to elicit a user to speak a respective utterance 102 in a first language. The initial prompt 161 includes a requested response 162 and an ideal answer 164. In some examples, the initial prompt 161 further includes a speaker turn boundary 166 between the requested response 162 and the ideal answer 164. The speaker turn boundary 166 indicates to the speech model 200 the transition between the information presented to the user 10 (e.g., the requested response 162) and the ideal answer 164. The requested response 162 may include an elicitor, such as a question or statement, that sets up a context for the user 10 to respond to the initial prompt 161. The prompt structurer 160 transmits the requested response 162 to the user interface 140 of the user device 110. The user interface 140 presents the requested response 162 to the user 10 via the user device 110. The requested response 162 may be presented to the user 10 via the user interface 140 in various formats. For instance, the requested response 162 may be presented as a textual representation on the screen 112 of the user device 110, as synthesized speech from the speaker 117 of the user device, as an image on the screen 112 of the user device 110, as a video on the screen of the user device 110, or any combination thereof. The requested response 162 may also be presented in multiple modalities simultaneously. For example, the requested response 162 may be presented as text on the screen while simultaneously being played as synthesized speech.

In some examples, the requested response 162 requests the user 10 to evaluate a statement, such as “fire is very hot” whereby the user 10 is supposed to evaluate the statement with a “yes” response. Another example is the statement “the sky is green,” where the user 10 would respond “no.” This type of initial prompt 161 helps in assessing the comprehension of the user 10 and their ability to make judgments in the first language. In another example, the requested response 162 requests the user 10 to repeat a phrase presented to the user 10. This exercise focuses on improving the pronunciation and memory recall of the user 10. For instance, the requested response 162 may include the phrase “this one is really broken” whereby the user 10 is expected to repeat the phrase verbatim. In some examples, the requested response 162 requests the user 10 to read a phrase presented to the user 10 aloud. This activity aims to enhance the reading fluency of the user 10. For instance, the phrase may be a fifty-word story that the user 10 is expected to read aloud. Alternatively, the user 10 may be expected to retell the phrase in their own words. In some scenarios, instead of the phrase being presented to the user 10 as text, the phrase is audibly presented to the user 10 whereby the user 10 is expected to retell the story verbatim or in their own words. For instance, if the user 10 hears “the quick brown fox jumps over the lazy dog,” the user 10 may retell it as “a fast brown fox leaps over a sleepy dog.” This scenario tests the ability of the user 10 to reproduce spoken language accurately.

In some examples, the requested response 162 includes a silent video that the user 10 is expected to narrate in real time as the silent video is presented to the user 10. This type of prompt is designed to assess the ability of the user 10 to describe visual information and to use language spontaneously. For instance, the user 10 may be expected to narrate “A man drops a ball from his backpack while walking in a park. A woman picks it up and hands it to him.” In yet other examples, the requested response 162 includes a phrase that the user 10 is expected to use in response to an elicitor. For example, the elicitor may be a question whereby the requested response 162 specifies a particular grammatical structure or vocabulary word that the user 10 should incorporate into their answer.

The ideal answer 164 is a reference representing how to correctly or appropriately respond to the requested response 162. For instance, if the requested response 162 is “repeat this ‘this one is really broken’ verbatim” the ideal answer 164 would be “this one is really broken.” In this instance, the ideal answer 164 is a direct repetition of the phrase given in the requested response 162. In 30 some scenarios, there are multiple ideal answers 164 for the requested response 162. For example, if the task is to retell a story in the user's 10 own words, there may be many acceptable ways to convey the same story accurately. Each version that accurately captures the essence and key details of the story may be considered an ideal answer 164. The ideal answer 164 serves as a benchmark for evaluating the response by the user 10. The conversational assistant 105 compares the spoken response to the ideal answer 164 to assess accuracy and provide feedback.

The prompt structurer 160 may generate the initial prompts 161 based on context 106. The context 106 may encompass a variety of factors that influence the generation of relevant and effective initial prompts 161 for the user 10. These factors include, but are not limited to, the first language the user 10 is learning, the second language (e.g., the native language of the user 10), the specific topic or subject matter of the learning activity, the difficulty level, the type of learning activity (e.g., reading, repeating, retelling, evaluating, conversing), the learning history and progress of the user 10, and feedback from the user 10. For example, if the user 10 is learning English and is interested in sports, the prompt structurer 160 may generate prompts related to sports topics. Moreover, the prompt structurer 160 may analyze the past performance of the user 10, identifying areas of strength and weakness to tailor initial prompts 161 that address specific learning needs. For instance, if the user 10 consistently struggles with verb conjugation, the prompt structurer 160 may generate prompts 161 that focus specifically on this grammatical aspect. The prompt structurer 160 may also generate multiple initial prompts 161 for the same activity type, and select one of them randomly or adaptively to present to the user 10. The prompt structurer 160 may also generate follow-up prompts 305 based on the utterance 102, the speech recognition result 202, or the accuracy 152, to provide further guidance, feedback, or challenge to the user 10. For instance, if the response of the user 10 is partially correct, the follow-up prompt 305 may provide additional hints or ask the user 10 to try again. These follow-up prompts 161 are configured to address specific errors made by the user 10, offer alternative ways to express the same idea, or gradually increase the complexity of the task.

The initial prompt 161 may be provided to the user 10 via the user interface 140. The initial prompt 161 is a text or audio message that presents the user 10 with a learning task in a first language that the user 10 is learning. For example, the initial prompt 161 may be a question, a statement, or a command in the first language. The user interface 140 may display the initial prompt 161 on the screen of the user device 110 as text. Additionally or alternatively, the initial prompt 161 may be audibly output from the speaker 117 of the user device 110 as synthesized speech. Thus, the initial prompt 161 serves to teach the user 10 a new language by eliciting a spoken response from the user 10 in the first language.

The user interface 140 may also provide other visual or auditory cues to the user 10, such as images, icons, animations, sounds, or music, to enhance user 10 engagement, motivation, or immersion in the learning task. For instance, a requested response 162 asking the user 10 to describe a picture may be accompanied by the picture itself and text asking the user 10 to describe the picture. The user interface 140 may also allow the user 10 to control the volume, the speed, the pitch, or the accent of the audio output of the initial prompt 161, or to replay, pause, or skip the initial prompt 161. The user interface 140 may also display the requested response 162 and/or the ideal answer 164 to the user 10, either before, during, or after the user 10 speaks the utterance 102, depending on the activity type and the preference of the user 10. For example, the ideal answer 164 may be displayed after the user 10 has attempted a response, allowing them to compare their own utterance to the correct or preferred version. Alternatively, for certain activity types, the user 10 may choose to view the ideal answer 164 beforehand to better understand the task at hand.

In some examples, the learning task of the initial prompt 161 includes providing an evaluation sentence whereby the user 10 is expected to respond with “yes” or “no.” For instance, the initial prompt 161 may be “Evaluate this sentence: fire is very hot. Respond: yes or no.” This example prompt tests the user's comprehension of basic factual statements in the target language. This type of task helps in assessing the comprehension and ability to make quick decisions in the target language. In other examples, the learning task includes a repeat task whereby the requested response 162 includes the user 10 repeating a phrase presented to the user 10 and the ideal answer 164 includes the phrase. For instance, the requested response 162 may include audio output to the user 10 of “repeat this phrase: this one is really broken” whereby the ideal answer 164 is the user 10 speaking “this one is really broken.” Repeat tasks are particularly useful for improving pronunciation and fluency. By comparing the utterance 102 spoken by the user 10 to the ideal answer 164, the conversational assistant 105 may provide feedback on pronunciation accuracy, intonation, and rhythm.

In some implementations, the learning task is reading a phrase presented to the user 10. Here, the requested response 162 includes the user 10 reading the phrase presented to the user 10 and the ideal answer 164 includes the phrase. Reading tasks help in enhancing the user's reading skills and understanding of sentence structure. In some examples, the learning task includes a retell task whereby the requested response 162 instructs the user 10 to retell a story or a passage presented to the user 10 in their own words and the ideal answer 164 includes a summary or a paraphrase of the story or the passage. For instance, the requested response 162 may include audio output to the user 10 of “listen to this story and then retell it in your own words” whereby the ideal answer 164 is the user 10 speaking a coherent and relevant retelling of the story. Retell tasks are effective in assessing the comprehension and ability to summarize information by the user 10. In some implementations, the learning task is answering a question or using a phrase in reply to an elicitor. For example, the requested response 162 may include audio output to the user 10 of “use this phrase in reply to the question: what should we do tonight? Phrase: movie” whereby the ideal answer 164 is the user 10 speaking a sentence that uses the phrase and makes sense with the question, such as “we can go to the movies.” This type of task helps in improving the user's 10 conversational skills and ability to use specific phrases in context.

After transmitting the requested response 162 to the user device 110, the speech model 200 is configured to receive audio data 104 of the utterance 102 in a first language spoken by the user 10 and the initial prompt 161 and determine a transcription (e.g., speech recognition result) 202 for the utterance 102. The utterance 102 in the first language spoken by the user 10 may include an accent associated with speakers of the second language. The speech model 200 may be trained to recognize speech in the first language. In some examples, the speech model 200 includes an ASR model. In other examples, the speech model 200 includes a multimodal large language model (LLM) configured to process audio, text, image, and video inputs. The utterance 102 is the spoken response by the user 10 to the initial prompt 161. The user 10 may be a native speaker of a second language different than the first language. The speech model 200 may be a large-scale end-to-end automatic speech recognition system, such as Whisper or Gemini, that can handle context-aware prompts and domain-invariant speech recognition. The speech model 200 may use the ideal answer 164 as context to improve the accuracy and robustness of the speech recognition result 202, especially for short or ambiguous utterances 102.

Specifically, the speech model 200 may leverage the linguistic information present in the ideal answer 164, such as the words, phrases, and grammatical structures, to constrain the possible interpretations of the utterance 102 spoken by the user 10. This contextual information allows the speech model 200 to more accurately identify the intended words and phrases even if the pronunciation by the user 10 deviates from standard pronunciation or if there is background noise. By incorporating the ideal answer 164, the speech model 200 better understands the expected response, thereby reducing errors and improving the overall quality of the recognition result 202. This approach is especially useful in educational settings, where accurate feedback is crucial for effective learning. The speech model 200's ability to adapt to different linguistic contexts ensures that it can provide reliable transcriptions for users with diverse language backgrounds and proficiency levels. Moreover, the use of the ideal answer 164 as context may improve the ability of the speech model 200 to handle code-switching, where the user 10 mixes words or phrases from their native language (the second language) with the target language (the first language).

The ideal answer 164 may include text, audio, or an image that provides an example of a correct or expected response to the initial prompt 161 in the first language. By using the ideal answer 164 as a reference, the speech model 200 is able to better understand the nuances of the speech of the user 10, leading to more accurate transcriptions 202. The ideal answer 164 provides a benchmark for the expected response, which helps the speech model 200 to filter out irrelevant or nonsensical responses. For example, if the initial prompt 161 is “Hey, what should we do tonight?” and the ideal answer 164 is “movie,”' the speech model 200 uses the context of the ideal answer 164 to recognize the word “movie” more accurately, even if the user 10 pronounces the term with a strong accent or a different stress pattern. Advantageously, using the ideal answer 164 helps the speech model 200 to distinguish the word “movie” from other acoustically similar words, such as “move” or “mood,” that may not make sense in the context of the initial prompt 161. In some implementations, the ideal answer 164 may be provided to the user 10 via the user interface 140 along with the initial prompt 161, or the ideal answer 164 may be hidden from the user 10 and only used by the speech model 200 as context.

The speech model 200 may also use the requested response 162 as context to bias the speech recognition result 202 towards the expected or sensible responses for the given activity. That is, the conversational assistant 105 conditions the speech model 200 on the initial prompt 161 (e.g., the requested response 162 and/or the ideal answer 164). For example, if the requested response 162 is to use the phrase “movie” in a reply to the initial prompt 161, the speech model 200 may favor responses that include the word “movie” and that have semantic cohesiveness with the initial prompt 161. Here, the speech model may favor utterances 102 that include the word “movie,” such as “We can go to the movies” or “How about watching a movie at home?” over responses that do not, such as “I like pizza.” The requested response 162 may help the speech model 200 to filter out irrelevant or nonsensical responses that may not reflect the language proficiency or comprehension of the user 10. Using the ideal answer 164 and the requested response 162 as context enables the speech model 200 to improve the accuracy and reliability of the speech recognition result 202, which may be used for providing feedback, assessment, or guidance to the user 10. The context-aware approach ensures that the speech model 200 may process various accents, dialects, and speech patterns, making it more robust and adaptable to different users. By leveraging the ideal answer 164 and the requested response 162, the speech model 200 may provide more precise and accurate transcriptions 202, enhancing the overall learning experience for the user 10.

In some implementations, the requested response 162 includes a yes or no response based on a phrase presented to the user 10 and the ideal answer 164 includes a yes or no response. Here, the ideal answer 164 may include the correct yes or no response based on the phrase presented to the user 10. Alternatively, the ideal answer 164 may include the phrase presented to the user 10 such that the speech model 200 determines whether “yes” or “no” is the correct response. In some examples, the requested response 162 includes the user 10 repeating a phrase presented to the user 10 whereby the ideal answer 164 includes the same phrase presented to the user 10. In other examples, the requested response 162 includes the user 10 reading the phrase presented to the user 10 whereby the ideal answer 164 includes the phrase presented to the user 10. In yet other examples, the requested response 162 includes the user 10 retelling the phrase in their own words. Here, the ideal answer may include an alternative version of the phrase. For instance, if the presented phrase is “The cat sat on the mat,” the ideal answer 164 may include variations such as “A feline rested upon the rug” or “The cat was seated on the mat,” allowing the speech model 200 to recognize and accept these different ways of expressing the same idea. This flexibility enhances the ability of the speech model 200 to understand the utterance 102.

In some implementations, the requested response 162 includes the user 10 narrating a scene in an image presented to the user 10 in their own words whereby the ideal answer 164 includes the image. Notably, the multimodal capabilities of the speech model 200 may determine a narration of the scene in the image and use the determined narration to condition the speech model 200. This allows the speech model 200 to leverage its understanding of the image content to better interpret the narration by the user 10. In some examples, the requested response 162 includes the user 10 describing a silent video whereby the ideal answer 164 is the silent video. Notably, the multimodal capabilities of the speech model 200 may determine the description of the silent video and use the determined description to condition the speech model 200. Similar to the image example, this allows the speech model 200 to leverage its understanding of the video content to better interpret the description by the user 10. For example, if the image shows a cat sitting on a mat, the speech model 200 anticipates that the user 10 may mention the cat, the mat, or the action of sitting. This allows the speech model 200 to better recognize and understand the utterances 102 spoken by the user, even if the speech is unclear or ambiguous. In addition, the speech model 200 may use the visual information to identify and correct errors in the utterances 102 spoken by the user 10. For example, if the user 10 says “The dog is sitting on the mat” when the image shows a cat, the speech model 200 may use the visual information to identify the error and suggest the correction “The cat is sitting on the mat.”

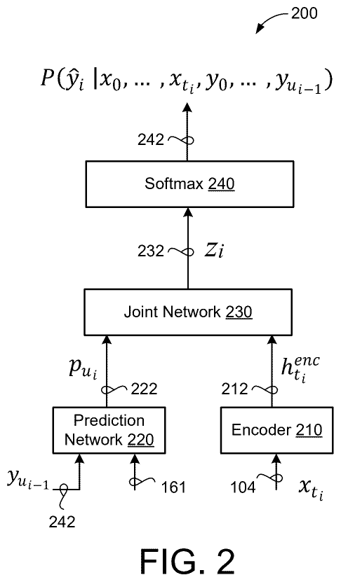

Referring now to FIG. 2, in some implementations, the speech model 200 includes an ASR model with a Recurrent Neural Network-Transducer (RNN-T) model architecture which adheres to latency constraints associated with interactive applications. The use of the RNN-T model architecture is exemplary only, and the speech model 200 may include other architectures such as transformer-transducer and conformer-transducer model architectures among others. The RNN-T model provides a small computational footprint and utilizes less memory requirements than conventional ASR architectures, making the RNN-T model architecture suitable for performing speech recognition entirely on the user device 110 (e.g., no communication with a remote server is required). The RNN-T model includes the audio encoder 210, the prediction network 220, and the joint network 230. The encoder 210, which is roughly analogous to an acoustic model (AM) in a traditional ASR system, includes a recurrent network of stacked Long Short-Term Memory (LSTM) layers. For instance, the audio encoder 210 reads a sequence of d-dimensional feature vectors (e.g., audio data 104) x=(x₁, x₂, . . . , x_{T}), where xₜ∈ [symbol] , and produces, at each of a plurality of output steps, a higher-order feature representation 212. This higher-order feature representation 212 may also be denoted as h₁^{enc}, . . . , h_{T}^{enc}.

Similarly, the prediction network 220 is also an LSTM network, which, like a language model (LM), processes the sequence of non-blank symbols 242 output by a final Softmax layer 240 so far, y₀, . . . , yᵤᵢ₋₁, and the initial prompt 161 into a dense representation (Pᵤ_{ᵢ}) 222. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network 230 then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution 232 over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 230 can include a posterior probability value for each of the different output labels. Thus, if there are one-hundred different output labels representing different graphemes or other symbols, the output yᵢ of the joint network 230 can include one-hundred different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model at the corresponding output step. In this manner, the RNN-T model does not make any conditional independent assumptions, rather the prediction of each symbol is conditioned not only on the acoustic frames but also on the sequence of labels output so far. As such, the Softmax layer 240 may select the speech recognition hypothesis having a highest corresponding probability from the probability distribution as the transcription 202. The RNN-T model does assume an output symbol is independent of future acoustic frames, which allows the RNN-T model to be employed in a streaming fashion, a non-streaming fashion, or some combination thereof.

In some examples, the audio encoder 210 of the RNN-T model includes a plurality of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance 16 layers. Moreover, the audio encoder 210 may operate in a streaming fashion (e.g., the encoder 210 outputs the higher-order feature representations 212 as soon as they are generated) or in a non-streaming fashion whereby the encoder 210 processes additional right-context to improve upon the speech recognition results.

Referring back to FIG. 1, the evaluator 150 is configured to determine an accuracy 152 of the utterance 102 spoken by the user 10. In particular, the evaluator 150 determines the accuracy 152 by comparing the transcription 202 to the ideal answer 164 of the initial prompt 161. The evaluator 150 may use various metrics to measure the accuracy 152, such as word error rate, phrase precision, phrase recall, or semantic similarity. The evaluator 150 may also provide feedback to the user 10 based on the accuracy 152, such as a score, a grade, a comment, or a correction. The feedback 154 may be displayed on the screen 112 of the user device 110 or audibly output from the speaker 117 of the user device 110. The feedback 154 may help the user 10 improve their language skills by identifying strengths and weaknesses and providing guidance or reinforcement. The ability of the evaluator 150 to use multiple metrics ensures a comprehensive assessment of the performance by the user 10, addressing not only the correctness of the response but also the fluency and coherence of the spoken language. By offering detailed feedback, the evaluator 150 helps the user 10 understand specific areas that need improvement, such as pronunciation, grammar, or vocabulary usage, thereby facilitating targeted learning and practice.

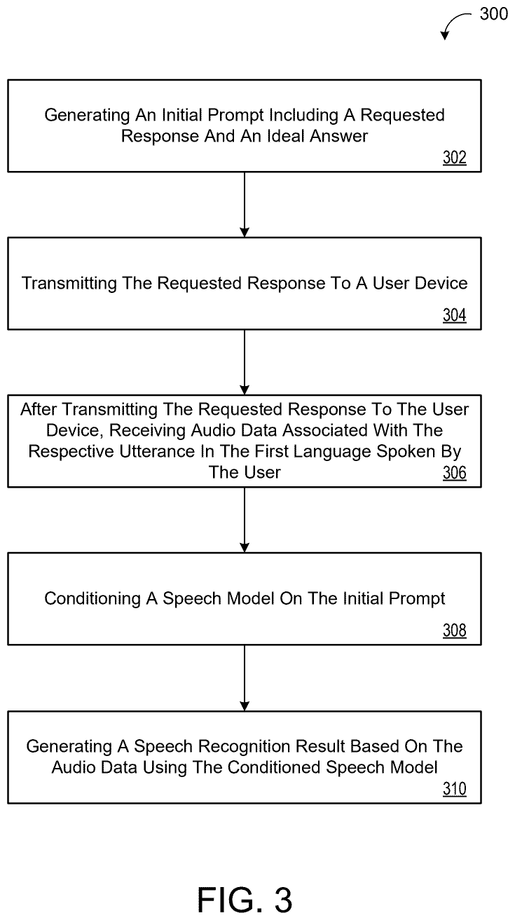

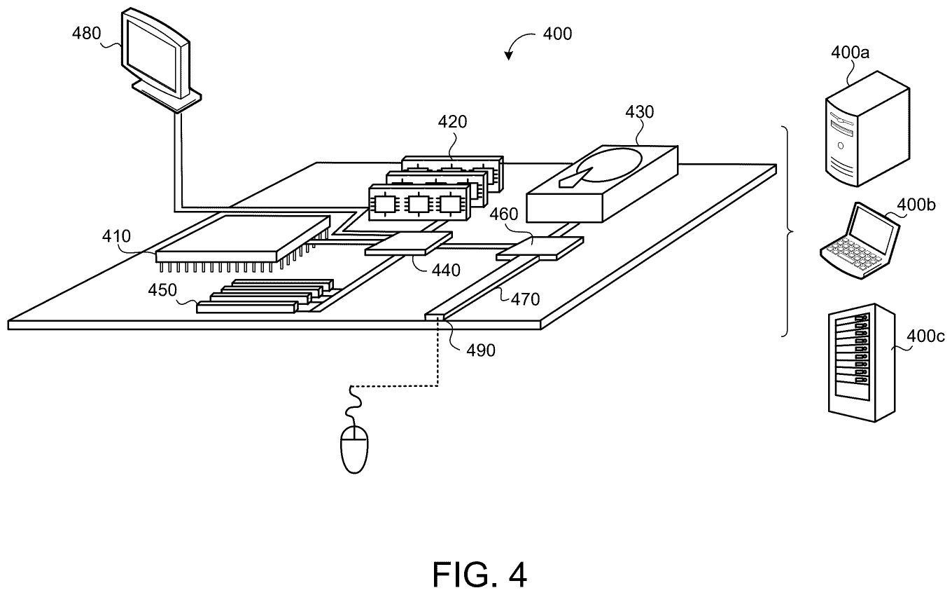

FIG. 3 is a flowchart of an example arrangement of operations for a computer-implemented method 300 of context-aware speech recognition. The method 300 may execute on the data processing hardware 410 (FIG. 4) using instructions stored on the memory hardware 420 (FIG. 4). The data processing hardware 410 and the memory hardware 420 may reside on the user device 110 and/or the remote computing device 120 of FIG. 1 each corresponding to the computing device 400 (FIG. 4).

At operation 302, the method 300 includes generating an initial prompt 161 including a requested response 162 and an ideal answer 164. The requested response 162 configured to elicit a user 10 to speak a respective utterance in a first language. The ideal answer 164 represents how to correctly respond to the requested response 162. At operation 304, the method 300 includes transmitting the requested response 162 to a user device 110 associated with the user 10. The user 10 may be a native speaker of a second language different than the first language. After transmitting the requested response 162 to the user device 110, at operation 306, the method 300 includes receiving audio data 104 associated with the respective utterance 102 in the first language spoken by the user 10. At operation 308, the method 300 includes conditioning a speech model 200 on the initial prompt 161 (e.g., the requested response 162 and/or ideal answer 164). At operation 310, the method 300 includes generating a speech recognition result 202 based on the audio data 104 using the conditioned speech model 200.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
generating an initial prompt comprising a requested response and an ideal answer, the requested response configured to elicit a user to speak a respective utterance in a first language, the ideal answer representing how to correctly respond to the requested response;
transmitting, to a user device associated with the user, the requested response, the user comprising a native speaker of a second language different than the first language;
after transmitting the requested response to the user device, receiving audio data associated with the respective utterance in the first language spoken by the user;
conditioning a speech model on the initial prompt; and
generating, using the conditioned speech model, a speech recognition result based on the audio data.

2. The computer-implemented method of claim 1, wherein:
the speech model comprises an automatic speech recognition (ASR) model; and
generating the speech recognition result comprises:
generating, using an audio encoder of the ASR model, a higher order feature representation based on the audio data;
generating, using a prediction network of the ASR model, a dense representation based on a sequence of non-blank output symbols output by a final Softmax layer and the initial prompt; and
generating, using a joint network of the ASR model, the speech recognition result based on the higher order feature representation and the dense representation.

3. The computer-implemented method of claim 1, wherein the speech model is trained to recognize speech in the first language.

4. The computer-implemented method of claim 1, wherein the speech model comprises a multimodal large language model (LLM).

5. The computer-implemented method of claim 1, wherein the user is learning to speak the first language.

6. The computer-implemented method of claim 1, wherein the utterance in the first language spoken by the user comprises an accent associated with speakers of the second language.

7. The computer-implemented method of claim 1, wherein:
the requested response comprises a yes or no response based on a phrase presented to the user; and
the ideal answer comprises yes or no.

8. The computer-implemented method of claim 1, wherein:
the requested response comprises at least one of:
the user repeating a phrase presented to the user;
the user reading the phrase presented to the user; or
the user retelling the phrase in their own words; and
the ideal answer comprises the phrase.

9. The computer-implemented method of claim 1, wherein:
the requested response comprises the user retelling a phrase associated with an image presented to the user in their own words; and
the ideal answer comprises the phrase and the image.

10. The computer-implemented method of claim 1, wherein:
the requested response comprises the user describing a silent video; and
the ideal answer comprises the silent video.

11. The computer-implemented method of claim 1, wherein the initial prompt further comprises a speaker turn boundary between the requested response and the ideal answer.

12. A system comprising:
data processing hardware; and
memory hardware in communication with the data processing hardware, the memory hardware storing instructions that when executed on the data processing hardware cause the data processing hardware to perform operations comprising:
generating an initial prompt comprising a requested response and an ideal answer, the requested response configured to elicit a user to speak a respective utterance in a first language, the ideal answer representing how to correctly respond to the requested response;
transmitting, to a user device associated with the user, the requested response, the user comprising a native speaker of a second language different than the first language;
after transmitting the requested response to the user device, receiving audio data associated with the respective utterance in the first language spoken by the user;
conditioning a speech model on the initial prompt; and
generating, using the conditioned speech model, a speech recognition result based on the audio data.

13. The system of claim 12, wherein:
the speech model comprises an automatic speech recognition (ASR) model; and
generating the speech recognition result comprises:
generating, using an audio encoder of the ASR model, a higher order feature representation based on the audio data;
generating, using a prediction network of the ASR model, a dense representation based on a sequence of non-blank output symbols output by a final Softmax layer and the initial prompt; and
generating, using a joint network of the ASR model, the speech recognition result based on the higher order feature representation and the dense representation.

14. The system of claim 12, wherein the speech model is trained to recognize speech in the first language.

15. The system of claim 12, wherein the speech model comprises a multimodal large language model (LLM).

16. The system of claim 12, wherein the user is learning to speak the first language.

17. The system of claim 12, wherein the utterance in the first language spoken by the user comprises an accent associated with speakers of the second language.

18. The system of claim 12, wherein:
the requested response comprises a yes or no response based on a phrase presented to the user; and
the ideal answer comprises yes or no.

19. The system of claim 12, wherein:
the requested response comprises at least one of:
the user repeating a phrase presented to the user;
the user reading the phrase presented to the user; or
the user retelling the phrase in their own words; and
the ideal answer comprises the phrase.

20. The system of claim 12, wherein:
the requested response comprises the user retelling a phrase associated with an image presented to the user in their own words; and
the ideal answer comprises the phrase and the image.

21. The system of claim 12, wherein:
the requested response comprises the user describing a silent video; and
the ideal answer comprises the silent video.

22. The system of claim 12, wherein the initial prompt further comprises a user turn boundary between the requested response and the ideal answer.
